(19) United States
(12) Patent Application Publication
(10) Pub. No.: US 2008/0199059 A1
(43) Pub. Date: Aug. 21, 2008

(54) Information Enhanced Image Guided Interventions

(75) Inventors: Kai Eck, Aachen (DE); Jorg Bredno, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,991

(22) PCT Filed: May 9, 2005
(86) PCT No.: PCT/IB05/51497

§ 371 Date: Nov. 13, 2006

(30) Foreign Application Priority Data
May 14, 2004 (EP) 04102126.2

(51) Int. Cl. G06T 5/00

(52) U.S. Cl. 382/128

(57) ABSTRACT

Linking of interventional and real time ultrasonic information with nonereal time anatomical information of, for example, a vessel or a tumor vascularization provided by x-ray rotational angiography requires high computational performance. According to an aspect of the present invention, an ultrasonic reference image is calibrated with respect to a high quality image acquired by a different imaging system. Then, during operational intervention, a registration or calibration of a data set acquired during the intervention is performed with respect to the reference image and not (as in state of the art devices) to the high quality image. Advantageously, this may allow for a fast fusion of the high quality image with the real time images and therefore allow for an improved tracking of operational interventions performed on a patient.

The present invention relates to digital imaging, for example, in the field of medical imaging. In particular, the present invention relates to a device for linking a second data set to a first data set, to a method of linking a second data set to a first data set and to a computer program for linking a second data set to a first data set.

Minimal invasive interventions require real time (or only little delayed) interventional image feedback. Typically, the diagnostic images or volumes are optimally adjusted to display the important features of the volume while they are not capable to display the volume interactively. Examples are x-ray rotational angio, MRI, CT and PET. On the other hand, interventional imaging methods are able to image the physicians activities in real time, but lack the required image quality or do not display some of the important functional or anatomical features at all.

For interventional imaging, it is highly desirable to link the information with diagnostic volumes to the real time interventional volumes in a way that allows the physician to use the (animated) diagnostic volume as a source of feedback for his manipulations. In this way, the superior quality of the diagnostic information can be delivered together with the interactive character of the interventional imaging system's information.

A typical example is the fusion of x-ray rotational angiographic volumes (giving anatomical information on the vessels) and ultrasound volumes (imaging the tumor in real time) during intervention. In many cases, tumor treatment requires the combined use of embolization and ablation. While the embolization is done in the Cathlab using intravascular catheters, a subsequent ablation is performed with a percutaneous ablation catheter using ultrasound imaging for real time feedback.

It is an object of the present invention to provide for improved imaging.

According to an exemplary embodiment of the present invention as set forth in claim 1, the above object may be solved by a device for linking a second data set to a first data set, the device comprising a first data port for receiving the first data set acquired by a first imaging system to the device and a second data port for receiving the second data set and a third data set acquired by a second imaging system to the device. The second imaging system is different from the first imaging system and the third data set is linked to the first data set. Furthermore, the device comprises a memory for storing the first data set, the second data set and the third data set and an image processor adapted for performing the following operation: loading the first, second and third data sets and linking the second data set to the third data set, resulting in a linkage of the second data set to the first data set via the third data set.

For example, before an operation, a patient may be examined by a first imaging system acquiring a first (high quality or functional or molecular) data set and by a second imaging system (which is different from the first imaging system) acquiring a third (lower quality or non-functional) data set of the same region. Later, during image acquisition or shortly after imaging acquisition, a calibration procedure may be performed, resulting in a linkage between the first data set and the third data set. During the operational intervention, a second data set is acquired by the second imaging system and linked to the third data set. Advantageously, linking of the second data set to the third data set is performed very fast, since the second data set and the third data set are acquired by the same (the second) imaging system, i.e. a registration of comparable data sets is performed. Therefore, a linkage between the second data set and the first data set has been established with the help of the third data set. Advantageously, by knowing the linkage between the first and the second data set, information from the second data set can be transferred to the first data set, for example by a multimodality fusion.

According to another exemplary embodiment of the present invention as set forth in claim 2, the third data set is acquired before acquisition of the second data set and the linkage of the third data set to the first data set is performed on the basis of one of a recorded position and a predefined position of the second imaging system relative to the first imaging system.

Advantageously, this may allow for a fast and accurate linking of the third data set to the first data set.

According to another exemplary embodiment of the present invention as set forth in claim 3, the linking of the second data set to the third data set comprises the steps of determining a translation from a first region of interest in the second data set to a second region of interest in the third data set and registering the second data set and the third data set on the basis of the translation. The first region of interest corresponds to the second region of interest.

Advantageously, according to this exemplary embodiment of the present invention, highly visible regions of interest may be determined in the second and third data sets, therefore allowing for a simple, reliable and accurate image registration.

According to other exemplary embodiments of the present invention as set forth in claims 4 and 5, the first imaging system is one of a CT scanner system, an MRI scanner system, a PET scanner system, an SPECT scanner system, and an x-ray rotational angiographic system. Furthermore, the second imaging system is one of an ultrasound imaging system and an interventional MRI scanner system.

This may allow for high quality images or functional images from the first data set and for a fast acquisition of images, which may be of lower quality than the images from the first data, from the second and third data sets acquired by the second imaging system.

According to another exemplary embodiment of the present invention as set forth in claim 6, the first data set comprises a first object of interest and the second and third data sets comprise at least a first part of the first object of interest.

Advantageously, according to this exemplary embodiment of the present invention, the second imaging system does not necessarily have to acquire images of the whole first object of interest, but may take more detailed or smaller images from only a part of the first object of interest. This may improve the quality of the second and third data sets by focusing only on the part of the first object of interest, which is of high interest. Furthermore, by focusing only on a part of the first object of interest, computational costs may be effectively reduced.

According to another exemplary embodiment of the present invention as set forth in claim 7, the image processor is adapted for performing the following fusing of at least a second part of the second data set with at least a third part of the first data set on the basis of the linkage of the second data set to the first data set, resulting in a fused data set.

This may allow to generate a data set comprising anatomical end functional information at the same time.

According to another exemplary embodiment of the present invention as set forth in claim 8, the device further comprises means for displaying an image formed from the fused data set. This may allow for displaying information comprised in the first data set and second data set as an overlay. Advantageously, according to this exemplary embodiment of the present invention, only a part of the second data set may be fused with the first data set, resulting in an image comprising the whole information of the first data set and only selected information of the second data set (for example the position of a biopsy needle).

According to another exemplary embodiment of the present invention as set forth in claim 9, the device is adapted for determining a position of a second object of interest during an examination of the first object of interest, wherein the second data set is acquired during the examination of the first object of interest.

For example, according to this exemplary embodiment of the present invention, a user (for example a physician) may perform an examination of the first object of interest (for example an inner organ of a patient) wherein the examination is monitored by the second imaging system (such as an ultrasound imaging system or an interventional MRI scanner system). During the examination, the device automatically determines the position of the second object of interest (such as a biopsy needle, for example), which may be followed by a segmentation of the biopsy needle. In a further step, the second object of interest may then be fused into the first (high quality) data set.

According to another exemplary embodiment of the present invention as set forth in claim 10, the device is integrated in one of the first imaging system and the second imaging system.

Claim 11 sets forth a method of linking a second data set to a first data set, according to an exemplary embodiment of the present invention. The method comprises the steps of: acquiring the first data set by a first imaging system; acquiring a third data set by a second imaging system, wherein the second imaging system is different to the first imaging system and wherein the third data set is linked to the first data set; acquiring the second data set by means of the second imaging system; transmitting the first, second and third data sets to the device; and linking the second data set to the third data set, resulting in a linkage of the second data set to the first data set via the third data set.

Advantageously, this may allow for a fast, efficient and accurate imaging method, which may be used for a guided intervention.

Further exemplary embodiments of the methods according to the present invention are set forth in claims 12 to 15.

The present invention also relates to a computer program, which may, for example, be executed on a processor, such as an image processor. Such computer programs may, for example, be part of a CT scanner system, an MRI scanner system, a PET scanner system, a SPECT scanner system, an x-ray rotational angiography system or an ultrasound imaging system. The computer programs according to an exemplary embodiment of the present invention are set forth in claim 16. These computer programs may be preferably loaded into working memories of image processors. The image processors are thus equipped to carry out exemplary embodiments of the present invention. The computer programs may be stored on a computer readable medium, such as a CD-ROM. The computer programs may also be presented over a network, such as the WorldWideWeb and may be downloaded into the working memory of an image processor from such networks. Computer programs according to this exemplary embodiment of the present invention may be written in any suitable programming language, such as C++.

It may be seen as the gist of an exemplary embodiment of the present invention that a first imaging system acquires a first high quality image of an object of interest (such as, for example, a blood vessel) and that, during the same time or shortly after, a second imaging system, which is different from the first imaging system, acquires a third (lower quality) image of the object of interest. Due to a calibration procedure, the high quality image and the low quality image are linked with respect to each other. Now, after calibration, a second (lower quality) data set comprising second images is acquired (by the second imaging system) and a fusion of the first image with one of the second images is performed by registering the second image with the third image (which is easy, since the third and second images are acquired by the same imaging system) and then using the previously determined calibration. Advantageously, this may allow for a fast fusion of the first and second images and therefore allow for an improved tracking of operational interventions performed on a patient.

These and other aspects of the present invention will become apparent from and elucidated with reference to the embodiments described hereinafter.

Exemplary embodiments of the present invention will be described in the following, with reference to the following drawings:

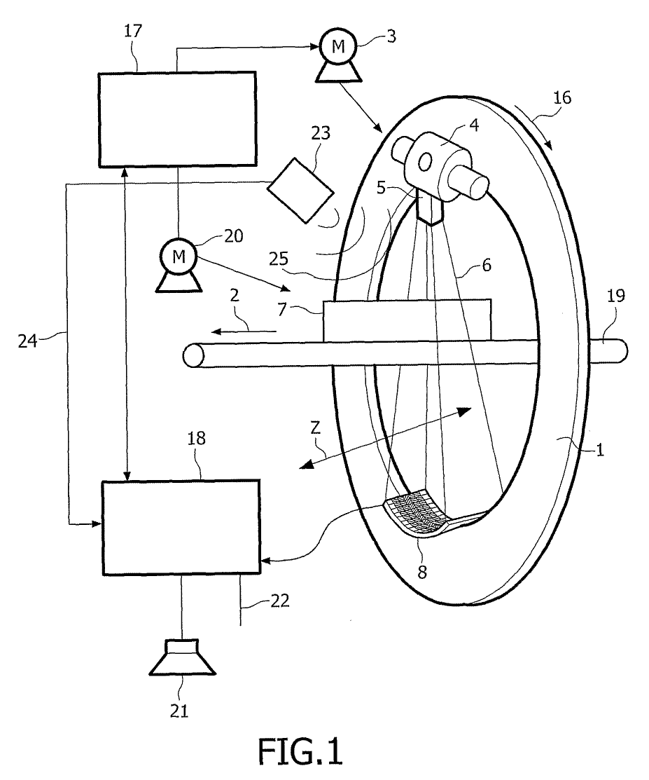

FIG. 1 shows a simplified schematic representation of a device for linking a second data set to a first data set acquired by an ultrasound scanner system and a CT scanner system, respectively, according to an exemplary embodiment of the present invention.

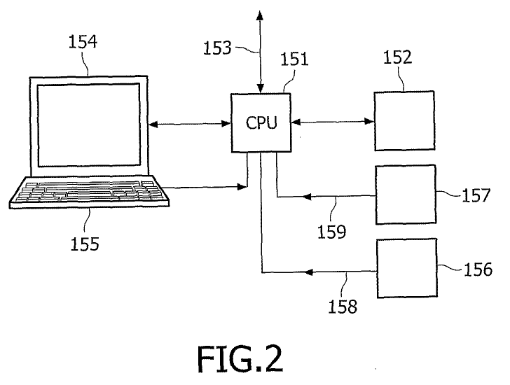

FIG. 2 shows another schematic representation of the device according to an exemplary embodiment of the present invention.

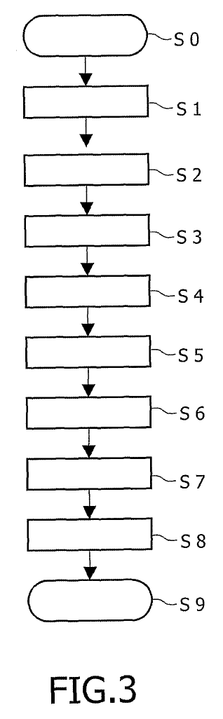

FIG. 3 shows a flow-chart of an exemplary embodiment of a method of linking a second data set to a first data set according to the present invention.

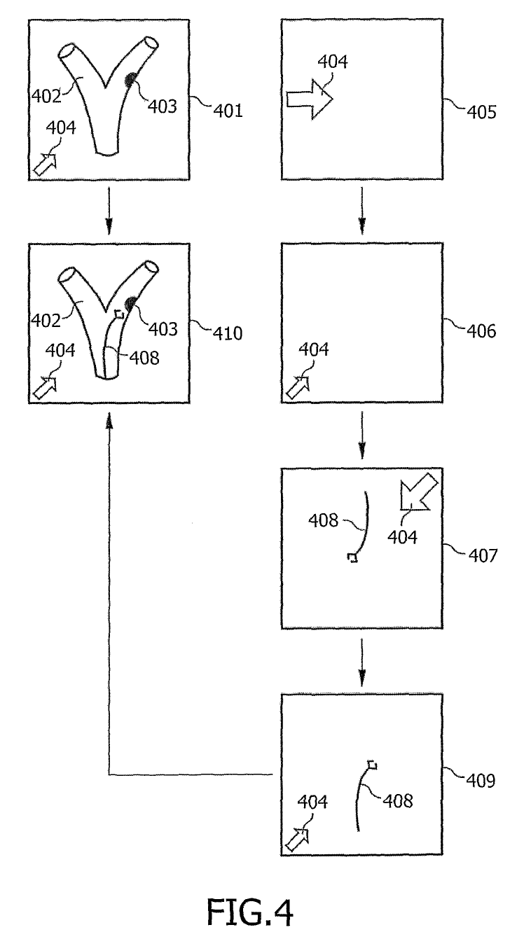

FIG. 4 shows images acquired by the first and second imaging systems and a schematic representation of an exemplary embodiment of the present invention.

FIG. 1 shows a schematic representation of an exemplary embodiment of the device for linking a second data set to a first data set, comprising a CT scanner system for acquisition of a first data set and an ultrasound scanner system 23 for acquisition of a second and third data set. With reference to this exemplary embodiment, the present invention will be described for the application in medical imaging. However, it should be noted that the present invention is not limited to the application in the field of medical imaging, but may be used in applications such as, for example, material testing.

The scanner depicted in FIG. 1 is a cone-beam CT scanner. The CT scanner depicted in FIG. 1 comprises a gantry 1, which is rotatable around a rotational axis 2. The gantry is driven by means of a motor 3. Reference numeral 4 designates a source of radiation such as an x-ray source, which, according to an aspect of the present invention, emits a polychromatic radiation beam.

Reference numeral 5 designates an aperture system, which forms a radiation beam emitted from the radiation source to a cone-shaped radiation beam 6.

The cone-beam 6 is directed such that it penetrates an object of interest 7 arranged in the centre of the gantry 1, i.e. in an examination region of the CT scanner, and impinges onto the detector 8. As may be taken from FIG. 1, the detector 8 is arranged on the gantry 1 opposite the source of radiation 4, such that the surface of the detector 8 is covered by the cone-beam 6. The detector 8 depicted in FIG. 1 comprises a plurality of detector elements.

During a scan of the object of interest 7, the source of radiation 4, the aperture system 5 and detector 8 are rotated along the gantry 1 in the direction indicated by arrow 16. For rotation of the gantry I with the source of radiation 4, the aperture system 5 and the detector 8, the motor 3 is connected to a motor control unit 17, which is connected to a calculation unit 18.

The object of interest is disposed on a conveyor belt 19. During the scan of the object of interest 7 while the gantry 1 rotates around the patient 7, the conveyor belt 19 displaces the object of interest 7 along a direction parallel to the rotational axis 2 of the gantry 1. By this, the object of interest 7 is scanned along a helical scan path. The conveyor belt 19 may also be stopped during the scans. Instead of providing a conveyor belt 19, for example, in medical applications, where the object of interest 7 is a patient, a movable table is used. However, it should be noted that in all of the described cases it is also possible to perform a circular scan, where there is no displacement in a direction parallel to the rotational axis 2, but only the rotation of the gantry 1 around the rotational axis 2.

The detector 8 is connected to the calculation unit 18. The calculation unit 18 receives a detection result, i.e. the read-outs from the detector element of the detector 8, and determines a scanning result on the basis of the read-outs. The detector elements of the detector 8 may be adapted to measure the attenuation caused to the cone-beam 6 by the object of interest. Furthermore, the calculation unit 18 communicates with the motor control unit 17 in order to coordinate the movement of the gantry 1 with motor 3 and 20 of the conveyor belt 19.

The calculation unit 18 may be adapted for reconstructing an image from read-outs of the detector 8. Furthermore, the calculation unit 18 may be adapted for performing the method according to the present invention. The fused image generated by the calculation unit 18 may be output to a display (not shown in FIG. 1) via an interface 22.

Furthermore, the system depicted in FIG. 1, comprises an ultrasound imaging system 23, which generates ultrasound waves 25 for the acquisition of the third and second data sets. These data sets are then received in the calculation unit 18 via a second data port 24. The first data set, which is acquired by the first imaging system (here the CT imaging system) is received in the calculation unit 18 via the first data port 25.

The calculation unit 18, which may be realized by an image processor integrated into an image processing device comprises a memory for storing the first, second and third data sets and may be adapted to perform the following operation: loading the first, second and third data sets and linking the second data set to the third data set, resulting in a linkage of the second data set to the first data set via the third data set.

Furthermore, as may be taken from FIG. 1, the calculation unit 18 may be connected to a loudspeaker 21 to, for example, automatically output an alarm.

It should be noted, that, although FIG. 1 depicts the device according to an exemplary embodiment of the present invention as being integrated in a CT scanner system or an ultrasound imaging system, the device may also be connected to or implemented in any other kind of suitable imaging systems for acquiring high quality or lower quality imaging data, such as, for example, MRI scanner systems, PET scanner systems, SPECT scanner systems or x-ray rotational angiographic systems (for acquisition of the high quality first data set) and interventional MRI scanner systems (for acquisition of the lower quality, real-time, second data set).

It should be noted, that, although the first data is often described as “high quality data”, it may also be “functional data” (e.g. acquired by a PET scanner system) or “molecular data”, which may not have a higher quality as the data acquired by the second imaging system, but may comprise different information.

FIG. 2 shows another schematic representation of the device according to an exemplary embodiment of the present invention, for executing an exemplary embodiment of a method in accordance with the present invention. The device depicted in FIG. 2 comprises a central processing unit (CPU) or image processor 151 connected to a memory 152 for storing first, second and third data sets of an object of interest, such as a patient. The image processor 151 may be connected to a plurality of input/output network or diagnosis devices, such as an MR device 157 for acquisition the second and third data sets and a CT device 156 for acquisition of a first data set. The first data set is transmitted to the image processor 151 via a first data port 158 and the second and third data sets are transmitted to the image processor 151 via the second data port 159. The image processor is furthermore connected to a display device 154, for example a computer monitor, for displaying information or an image computed or adqapted in the image processor 151. An operator may interact with the image processor 151 via a keyboard 155 and/or other output devices, which are not depicted in FIG. 2.

Furthermore, via the bus system 153, it is also possible to connect the image processing and control processor 151 to, for example, a motion monitor, which monitors a motion of the object of interest. In case, for example, a lung of a patient is imaged, the motion sensor may be an exhalation sensor. In case the heart is imaged, the motion sensor may be an electrocardiogram (ECG).

FIG. 3 shows a flow-chart of an exemplary embodiment of a method of linking a second data set to a first data set according to an exemplary embodiment of the present invention. The method starts at step S0, after which an acquisition of a first data set by a first imaging system is performed. The first data set may be a three-dimensional data set with high accuracy, acquired by, for example, a positron emission tomography scanner system (PET scanner system). During or shortly after acquisition of the first data set by the first imaging system, a third data set is acquired by a second imaging system. The second imaging system may be, for example, an ultrasound imaging system or an interventional MRI scanner system. The second imaging system is different to the first imaging system and, according to an aspect of the present invention, is adapted to acquire multi-dimensional data sets, such as, for example, three-dimensional data sets or four-dimensional data sets which may comprise, among three-dimensional volume data, information about a periodic movement of an object of interest (electrocardiogram data) or which may comprise a time series of three-dimensional data sets.

After that, in step S2, a calibration is performed, resulting in a linkage between the third data set and the first data set. The calibration is performed by determining a first translation from a first region of interest in the third data set to a second region of interest in the first data set, wherein the first region of interest corresponds to a second region of interest. Furthermore, the calibration may comprise a magnification shrinking the third data set, such that it is brought to the same scale as the first data set. Furthermore, the calibration may comprise a rotation of the third data set, such that its orientation now corresponds to the orientation of the first data set. Advantageously, the linkage of the third data set to the first data set is performed on the basis of a recorded or predefined position of the second imaging system relative to the first imaging system.

Then, in step S3, a second data set is acquired by means of the second imaging system, the second data set comprising the first object of interest. The second data set is acquired during an operational intervention performed by a physician, the intervention involving, for example, a biopsy. After acquisition of the second data set, a translation of the second data set to the third data set is determined in step S4. Determination of the second translation is performed by a selection of a third region of interest in the second data set and by a selection of a fourth region of interest in the third data set, wherein the third and fourth regions of interest correspond to each other.

After determination of the second translation, a registration of the second data set and the third data set is performed on the basis of the second translation. Furthermore, a calibration of the second data set may be performed, according to the previously performed calibration of the third data set. After that, in step S5, a second object of interest, for example a biopsy needle, is identified in the second data set acquired during an examination of the patient. After identifying the biopsy needle, a segmentation of the biopsy needle (second object of interest) from the second data set is performed in step S6.

Then, in step S7, the part of the second data set which comprises the second object of interest is fused with the first data set on the basis of the first and second translations, resulting in a fused data set comprising high quality data of the first object of interest and lower quality data of the second object of interest. Then, in step S8, an image is formed from the fused data set and displayed in order to guide the physician during the intervention.

The method ends at step S9.

FIG. 4 shows images acquired by the first and second imaging systems and schematically depicts an exemplary embodiment of the method according to the present invention. In the beginning, a first high quality image 401 is acquired by means of a first imaging system. Image 401 depicts a blood vessel 402 which comprises an accretion 403 which has to be removed during an intervention. Image 401 further comprises a region of high contrast 404, which is easily visible by ultrasound imaging and is taken as reference point. At the same time, image 405 is acquired by means of an ultrasound imaging system. As may be seen from FIG. 4, image 405 comprises the reference point 404, but rotated by approximately 45° and slightly magnified.

In a first processing step, the ultrasound image is calibrated with respect to the high quality CT image 401. This is depicted in image slice 406, which shows, that the image is rotated by −45° and is furthermore scaled down, according to CT image 401. After that, the patient may be taken to another room, for example, an operating room for performing the guided intervention.

During the guided intervention, images 407 are acquired by means of the ultrasound imaging system. As may be taken from image slice 407, the ultrasound image is rotated with respect to the calibrated (reference) ultrasound image 406 by approximately 180°. Furthermore, image 407 is magnified with respect to image 406. However, image 407 shows a second object of interest 408, which may be an operational tool, for example a biopsy needle for removing tissue or, as is the case here, for removing an accretion inside a blood vessel 402. Due to minimal or even no anatomical contrast, the blood vessel 402 or the accretion 403 are not visible in the ultrasound image 407.

However, in the next step, a translation between image 407 (second data set) and image 406 (third data set) is performed, followed by a calibration comprising a rotation by 180° and a down-scaling of image 407 to the scale of (calibrated) reference image 406. The result is depicted in image 409, comprising the reference mark 404 and the second object of interest 408, but now in the right size and right orientation 8 with respect to the reference image 403 and therefore to the high quality image 401.

After that, a segmentation of the biopsy needle 408 may be performed on the basis of known identification and segmentation procedures, such as a Hough Transform. Then, a fusion is performed, in which the image of the biopsy needle 408 is fused with the high quality image 401, resulting in the fused image 410, comprising the reference 404, the blood vessel 402, the accretion 403 and the biopsy needle 408.

In other words: Since the ultrasonic acquisition is done free hand, the overlay requires careful calibration of the two volumes and a compensation of the transducer position movement of the ultrasonic source. In order to perform the calibration, a part of the region of interest is imaged from a recorded or predefined position using the ultrasound imaging system during or shortly after the acquisition of the rotational angiography volume. This calibrated hybrid imaging arrangement gives a link from the interventional ultrasound to the anatomical rotational angiographic data. For compensation of the transducer motion, state of the art block matching methods may be used. Once the translation is known, the information from rotational angiography and ultrasound can be fused.

The present invention described above may, for example, be applied in the field of medical imaging. However, as described above, the present invention may also be applied in the field of non-destructive testing or baggage inspection. Advantageously, according to an aspect of the present invention, anatomical or functional and interventional volumes are acquired with a different modality and are linked using a calibrated acquisition of both modalities. This may allow for displaying anatomical and functional information with latency and rate of interventional imaging. Furthermore, a fast fusion of the high quality image with the real time images may be achieved and therefore the present invention may allow for an improved tracking of operational interventions performed on a patient. The present invention may be applied as add-on functionality for imaging systems.

It should be noted, that the term “comprising” does not exclude other elements or steps and the “a” or “an” does not exclude a plurality and that a single processor or system may fulfil the functions of several means recited in the claims. Also elements described in association with different embodiments may be combined.

It should also be noted, that any reference signs in the claims shall not be construed as limiting the scope of the claims.

1. A device for linking a second data set (407) to a first data set (401), the device comprising:
a first data port for receiving the first data set (401) acquired by a first imaging system to the device;
a second data port for receiving the second data set (407) and a third data set (405) acquired by a second imaging system to the device, wherein the second imaging system is different from the first imaging system and wherein the third data set (405) is linked to the first data set (401);
a memory for storing the first, second and third data sets; and
an image processor adapted for performing the following operation:
loading the first, second and third data sets; and
linking the second data set (407) to the third data set (405), resulting in a linkage of the second data set (407) to the first data set (401) via the third data set (405).

2. The device according to claim 1,
wherein the third data set (405) is acquired before acquisition of the second data set; and
wherein the linkage of the third data set (405) to the first data set (401) is performed on the basis of one of a recorded position and a predefined position of the second imaging system relative to the first imaging system.

3. The device according to claim 1,
wherein linking the second data set (407) to the third data set (405) comprises the steps of:
determining a translation from a first region of interest in the second data set (407) to a second region of interest in the third data set (405);
registering the second data set (407) and the third data set (405) on the basis of the translation;
wherein the first region of interest corresponds to the second region of interest.

4. The device according to claim 1,
wherein the first imaging system is one of a CT scanner system, an MRI scanner system, a PET scanner system, an SPECT scanner system, and an x-ray rotational angiography system.

5. The device according to claim 1,
wherein the second imaging system is one of an ultrasound imaging system and an interventional MRI scanner system.

6. The device according to claim 1,
wherein the first data set (401) comprises a first object of interest; and
wherein the second data set (407) and the third data set (405) comprise at least a first part of the first object of interest.

7. The device according to claim 1,
wherein the image processor is adapted for performing the following further operation:
fusing at least a second part of the second data set (407) with at least a third part of the first data set (401) on the basis of the linkage of the second data set (407) to the first data set (401), resulting in a fused data set.

8. The device according to claim 7, further comprising displaying means for displaying an image (410) formed from the fused data set.

9. The device according to claim 1,
wherein the device is adapted for determining a position of a second object of interest during an examination of the first object of interest; and
wherein the second data set (407)is acquired during the examination of the first object of interest.

10. The device according to claim 1,
wherein the device is integrated in one of the first imaging system and the second imaging system.

11. A method of linking a second data set (407) to a first data set (401), the method comprising the steps of:
acquiring the first data set (401) by a first imaging system;
acquiring a third data set (405) by a second imaging system, wherein the second imaging system is different to the first imaging system and wherein the third data set (405) is linked to the first data set;
acquiring the second data set (407) by means of the second imaging system;
transmitting the first, second and third data sets (407, 405) to the device; and
linking the second data set (407) to the third data set (405), resulting in a linkage of the second data set (407) to the first data set (401) via the third data set (405).

12. The method according to claim 11,
wherein the third data set (405) is acquired before acquisition of the second data set;
wherein the linkage of the third data set (405) to the first data set (401) is performed on the basis of one of a recorded position and a predefined position of the second imaging system relative to the first imaging system;
wherein linking the second data set (407) to the third data set (405) comprises the steps of:
determining a translation from a first region of interest in the second data set (407) to a second region of interest in the third data set (405);
registering the second data set (407) and the third data set (405) on the basis of the translation;
wherein the first region of interest corresponds to the second region of interest.

13. The method according to claim 11,
wherein the first imaging system is one of a CT scanner system, an MRI scanner system, a PET scanner system, an SPECT scanner system, and an x-ray rotational angio system; and
wherein the second imaging system is one of an ultrasound imaging system and an interventional MRI scanner system.

14. The method according to claim 11,
wherein the first data set (401) comprises a first object of interest; and
wherein the second data set (407) and the third data set (405) comprise at least a first part of the first object of interest;
wherein a position of a second object of interest during an examination of the first object of interest is determined; and
wherein the second data set is acquired during the examination of the first object of interest.

15. The method according to claim 11, further comprising the steps of:
fusing at least a second part of the second data set (407) with at least a third part of the first data set (401) on the basis of the linkage of the second data set (407) to the first data set (401), resulting in a fused data set; and
displaying an image (410) formed from the fused data set.

16. A computer program for linking a second data set (407) to a first data set (401), wherein the computer program causes an image processor to perform the following operation when the computer program is executed on the image processor:
loading the first data set, the second data set (407) and a third data set (405), wherein the third data set (405) is linked to the first data set; and
linking the second data set (407) to the third data set (405), resulting in a linkage of the second data set (407) to the first data set (401) via the third data set (405).
